(19) United States
(12) Patent Application Publication
(10) Pub. No.: US 2018/0329589 A1
(43) Pub. Date: Nov. 15, 2018

(54) Contextual Object Manipulation

(71) Applicant: Microsoft Technology Licensing, LLC, Redmond, WA (US)

(72) Inventors: Eduardo SONNINO, Vancouver (CA); Anthony DART, Redmond, WA (US); Ryan Chandler PENDLAY, Bellevue, WA (US); Jason M. NELSON, Sammamish, WA (US); March ROGERS, Bothell, WA (US); Zachary Adam PFRIEM, Seattle, WA (US); Jenny Angelica ALARCO DIEZ, Seattle, WA (US)

(73) Assignee: Microsoft Technology Licensing, LLC, Redmond, WA (US)

(21) Appl. No.: 15/640,215

(22) Filed: Jun. 30, 2017

Related U.S. Application Data
(60) Provisional application No. 62/506,487, filed on May 15, 2017.

(51) Int. Cl. G06F 3/0483; G06F 3/0482; G06F 1/16; G06F 3/0488

(52) U.S. Cl. CPC G06F 3/0483; G06F 3/0482; G06F 3/03545; G06F 3/04883; G06F 1/1616

(57) ABSTRACT

Techniques for contextual object manipulation are described. In one or more implementations, digital content is generated as an interactive canvas, and the interactive canvas is displayed on one or more display devices. Additional digital content is also generated as one or more objects, and the one or more objects are displayed on the interactive canvas. In response to detection of a user selection of an object displayed in the interactive canvas, a type of the selected object is determined. Next, one or more controls that are contextual to the selected object are displayed on the interactive canvas. In response to a user selection of one of the controls, the selected control is applied to the selected object.

### RELATED APPLICATION

This application claims priority to U.S. Provisional Application No. 62/506,487, filed May 15, 2017, entitled “Contextual Object Manipulation”, the disclosure of which is hereby incorporated by reference herein in its entirety.

### BACKGROUND

Increasingly, users interact with devices by providing user input to touch displays using a stylus or the user's finger. Using a stylus makes it easy for the user to provide “free-form” input to the display device, such as by writing or drawing on the display device. However, when the primary input device used to interact with the device is a stylus or the user's finger, it can be difficult for users to initiate other functions, such as accessing menus to insert objects or content into a canvas or manipulate or edit such objects. Furthermore, on devices with smaller displays (e.g., a smartphone or tablet), the display of such menus takes up valuable screen space which could be otherwise utilized by the user to create content.

### SUMMARY

Techniques for contextual object manipulation are described. In one or more implementations, digital content is generated as an interactive canvas, and the interactive canvas is displayed on one or more display devices. Additional digital content is also generated as one or more objects, and the one or more objects are displayed on the interactive canvas. In response to detection of a user selection of an object displayed in the interactive canvas, a type of the selected object is determined. Next, one or more controls that are contextual to the selected object are displayed on the interactive canvas. In response to a user selection of one of the controls, the selected control is applied to the selected object.

In one or more implementations, user input to add or modify metadata associated with the object is monitored. In response to detecting the user input to add or modify metadata associated with the object, a metadata manipulation mode is initiated to enable metadata to be added to the object or existing metadata associated with the object to be modified. In the metadata manipulation mode, writing input is received and stored as metadata associated with object.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment 100 in an example implementation that is operable to employ techniques for contextual object manipulation discussed herein.

FIGS. 2A-2E illustrate various examples of contextual object manipulation in accordance with one or more implementations.

FIG. 3 is a flow diagram that describes steps in a method for contextual object manipulation in accordance with one or more implementations.

FIG. 4 is a flow diagram that describes steps in an additional method for contextual object manipulation in accordance with one or more implementations.

FIG. 5 illustrates an example system that includes an example computing device that is representative of one or more computing systems and/or devices that may implement the various techniques described herein.

### DETAILED DESCRIPTION

Techniques for contextual object manipulation are described. In one or more implementations, digital content is generated as an interactive canvas, and the interactive canvas is displayed on one or more display devices. Additional digital content is also generated as one or more objects, and the one or more objects are displayed on the interactive canvas. As described herein, objects may include any type of content, such as images and photos, videos, audio files, text, symbols, drawings, and so forth. In response to detection of a user selection of an object displayed in the interactive canvas, a type of the selected object is determined and one or more controls that are contextual to the selected object are displayed on the interactive canvas. In one or more implementations, the one or more controls are displayed in an object manipulation menu. At least one of the controls are contextual to the selected object, such that the controls which are displayed for a picture are different than the controls surfaced for a video or audio file. In response to a user selection of one of the controls, the selected control is applied to the selected object.

In one or more implementations, user input to add or modify metadata associated with the object is monitored. In response to detecting the user input to add or modify metadata associated with the object, a metadata manipulation mode is initiated to enable metadata to be added to the object or existing metadata associated with the object to be modified. In the metadata manipulation mode, writing input is received and stored as metadata associated with object. In some cases, the metadata manipulation mode is initiated by changing the display of the object to enable the writing input to be received directly on the object, such as by causing the object to be flipped over to reveal a backside of the object corresponding to a blank surface configured to receive the writing input.

Thus, the described techniques improve a user experience by enabling the quick and efficient manipulation of objects displayed on an interactive canvas. Additionally, displaying the one or more controls dynamically and in response to user selection of an object maximizes screen space that can be utilized by the user to create, particularly as compared to conventional solutions which persistently display menu items.

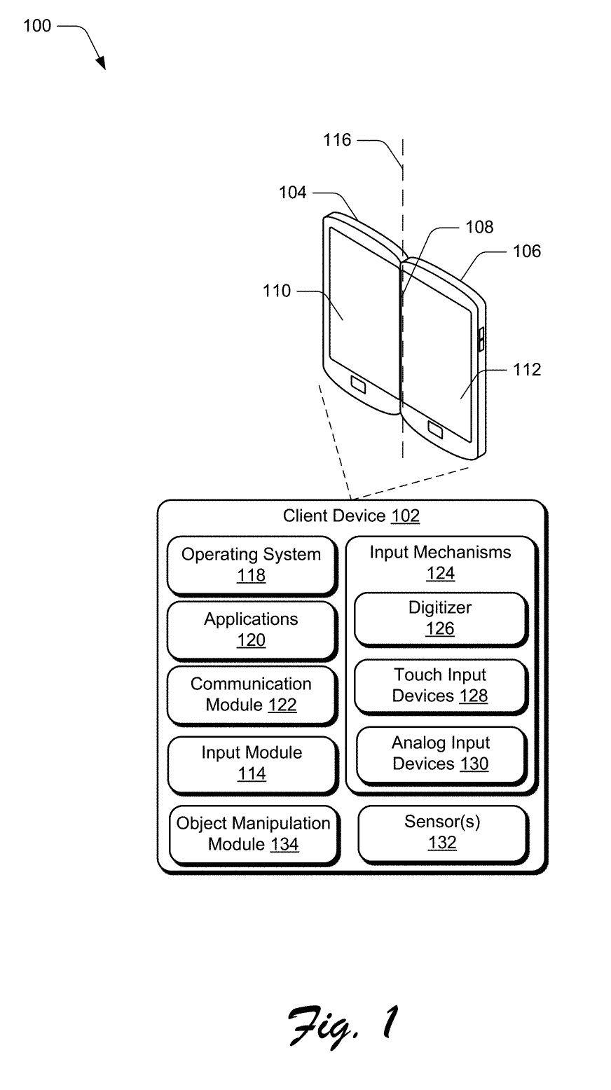

FIG. 1 is an illustration of an environment 100 in an example implementation that is operable to employ techniques for contextual object manipulation discussed herein. Environment 100 includes a client device 102 which can be configured for mobile use, such as a mobile phone, a tablet computer, a wearable device, a handheld gaming device, a media player, and so on. In this example, the client device 102 is implemented as a “dual-display” device, and includes a display device 104 and a display device 106 that are connected to one another by a hinge 108. The display device 104 includes a touch surface 110, and the display device 106 includes a touch surface 112. The client device 102 also includes an input module 114 configured to process input received via one of the touch surfaces 110, 112 and/or via the hinge 108. While some of the techniques discussed herein will be described with reference to a dual-display device, it is to be appreciated that in some cases the techniques may also be implemented on a single-screen device, such as a mobile phone, tablet computer, media player, laptop computer, desktop computer, and so forth. In addition, the hinge 108 may allow the display devices 104 and 106 to fold back on each other to provide a “single display” device. As such, the techniques described herein may be designed to function whether the user is operating in a two-display mode or a single-display mode. In addition, while the dual display device is illustrated with a hinge in this example, it is to be appreciated that in some cases the techniques may be implemented in single display, dual-display, or multi-display devices without the hinge.

The hinge 108 is configured to rotationally move about a longitudinal axis 116 of the hinge 108 to allow an angle between the display devices 104, 106 to change. In this way, the hinge 108 allows the display devices 104, 106 to be connected to one another yet be oriented at different angles and/or planar orientations relative to each other. In at least some implementations, the touch surfaces 110, 112 may represent different portions of a single integrated and continuous display surface that can be bent along the hinge 108.

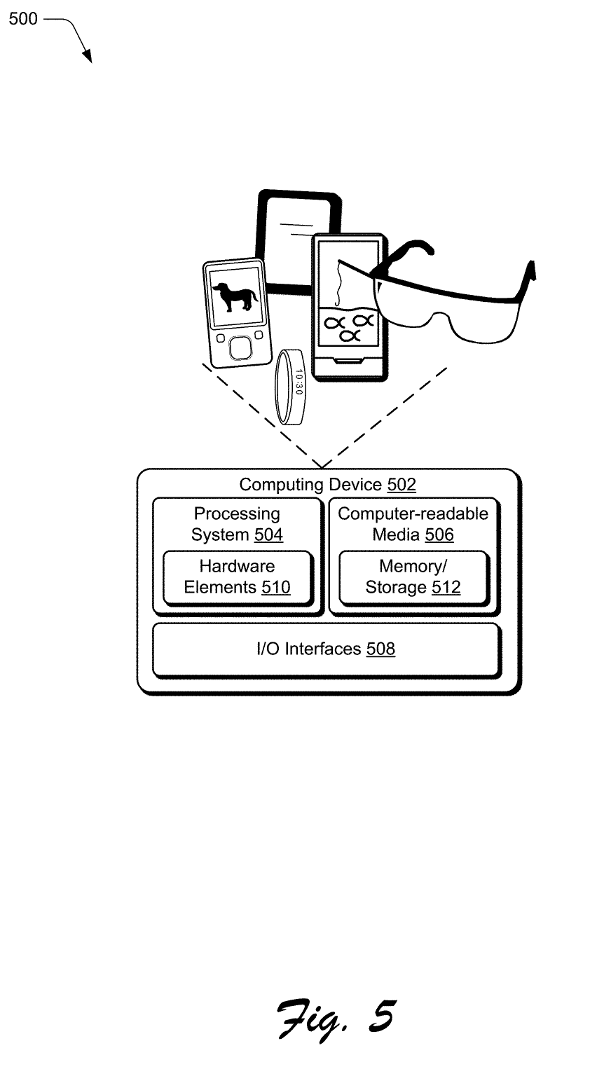

While implementations presented herein are discussed in the context of a mobile device, it is to be appreciated that various other types and form factors of devices may be utilized in accordance with the claimed implementations. Thus, the client device 102 may range from full resource devices with substantial memory and processor resources, to a low-resource device with limited memory and/or processing resources. An example implementation of the client device 102 is discussed below with reference to FIG. 5.

The client device 102 includes a variety of different functionalities that enable various activities and tasks to be performed. For instance, the client device 102 includes an operating system 118, applications 120, and a communication module 122. Generally, the operating system 118 is representative of functionality for abstracting various system components of the client device 102, such as hardware, kernel-level modules and services, and so forth. The operating system 118, for instance, can abstract various components (e.g., hardware, software, and firmware) of the client device 102 to enable interaction between the components and applications running on the client device 102.

The applications 120 are representative of functionality for performing different tasks via the client device 102. In one particular implementation, the applications 120 represent a web browser, web platform, or other application that can be leveraged to browse websites over a network.

The communication module 122 is representative of functionality for enabling the client device 102 to communicate over wired and/or wireless connections. For instance, the communication module 122 represents hardware and logic for communicating data via a variety of different wired and/or wireless technologies and protocols.

According to various implementations, the display devices 104, 106 generally represent functionality for visual output for the client device 102. Additionally, the display devices 104, 106 represent functionality for receiving various types of input, such as touch input, stylus input, touchless proximity input, and so forth via one or more of the touch surfaces 110, 112, which can be used as visual output portions of the display devices 104, 106. The input module 114 is representative of functionality to enable the client device 102 to receive input (e.g., via input mechanisms 124) and to process and route the input in various ways.

The input mechanisms 124 generally represent different functionalities for receiving input to the client device 102, and include a digitizer 126, touch input devices 128, and analog input devices 130. Examples of the input mechanisms 124 include gesture-sensitive sensors and devices (e.g., such as touch-based sensors), a stylus, a touch pad, accelerometers, a microphone with accompanying voice recognition software, and so forth. The input mechanisms 124 may be separate or integral with the display devices 104, 106; integral examples include gesture-sensitive displays with integrated touch-sensitive sensors.

The digitizer 126 represents functionality for converting various types of input to the display devices 104, 106, the touch input devices 128, and the analog input devices 130 into digital data that can be used by the client device 102 in various ways. The analog input devices 130 represent hardware mechanisms (e.g., the hinge 108) that are usable to generate different physical quantities that represent data. For instance, the hinge 108 represents a mechanism that can be leveraged to generate input data by measurement of a physical variable, such as hinge angle of the hinge 108. One or more sensors 132, for example, can measure the hinge angle, and the digitizer 126 can convert such measurements into digital data usable by the client device 102 to perform operations to content displayed via the display devices 104, 106.

Generally, the sensors 132 represent functionality for detecting different input signals received by the client device 102. For example, the sensors 132 can include one or more hinge sensors configured to detect a hinge angle between the display devices 104, 106. Additionally, the sensors 132 can include grip sensors, such as touch sensors, configured to detect how a user is holding the client device 102. Accordingly, a variety of different sensors 132 can be implemented to detect various different types of digital and/or analog input. These and other aspects are discussed in further detail below.

In one particular implementation, the applications 120 represent a journal application which generates and displays digital content as an interactive canvas representative of pages of a journal. For example, a first page of the journal application can be displayed on touch surface 110 of display device 104 while a second page of the journal application is displayed on touch surface 112 of display device 106. The user can then write and draw on the interactive canvas, as well as insert and/or manipulate various different objects.

In at least some implementations, the applications 120 include or otherwise make use of an object manipulation module 134. The object manipulation module 134, for example, represents a standalone application. In other implementations, the object manipulation module 134 is included as part of another application or system software, such as the journal application or operating system 118. Generally, the object manipulation module 134 is configured to display controls that are contextual to a selected object in order to enable quick and efficient manipulation of the selected object. Further discussion of this and other features is provided below.

Having described an example environment in which the techniques described herein may operate, consider now a discussion of some example implementation scenarios in accordance with one or more implementations.

This section describes some example implementation scenarios in accordance with one or more implementations. The implementation scenarios may be implemented in the environment 100 described above, the system 500 of FIG. 5, and/or any other suitable environment. The implementation scenarios and procedures, for example, describe example operations of the client device 102.

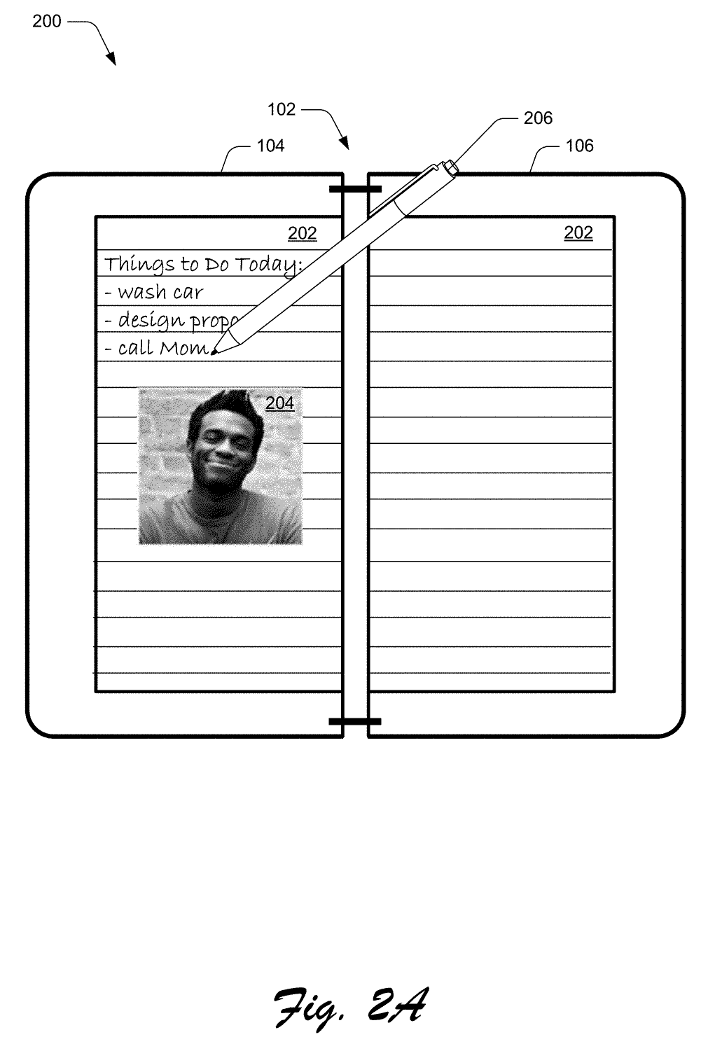

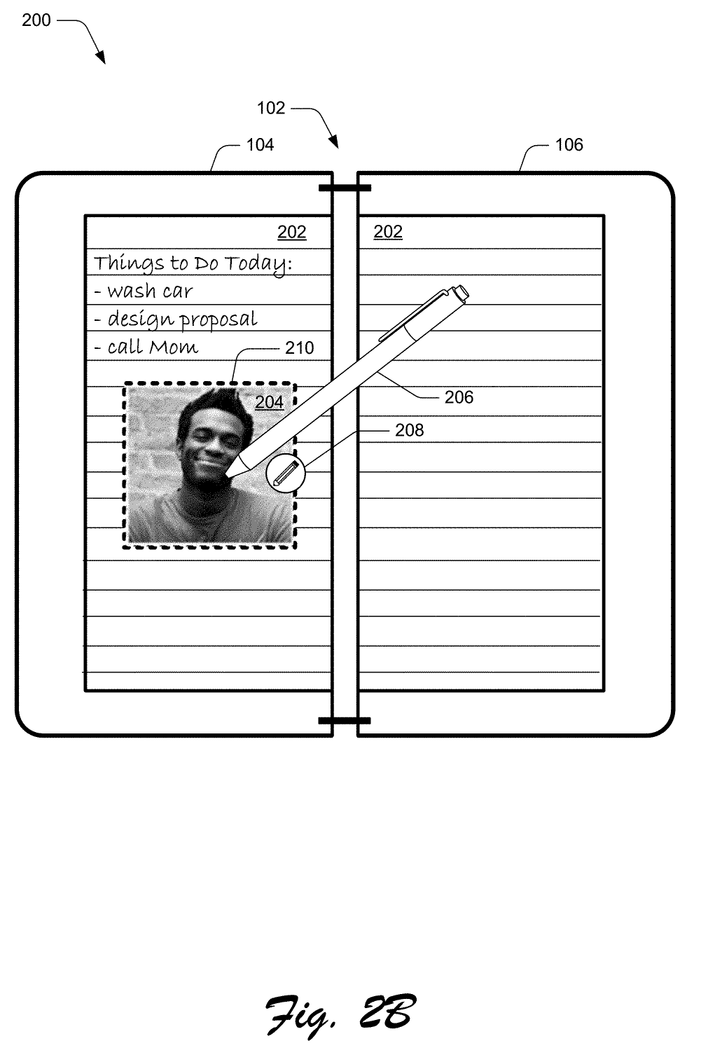

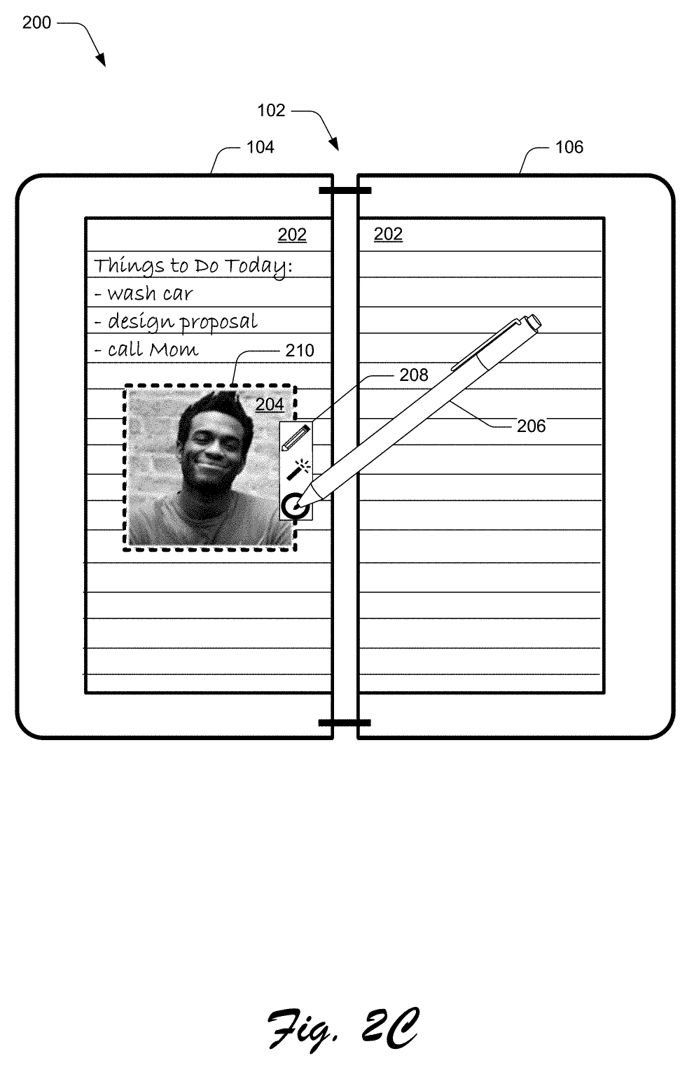

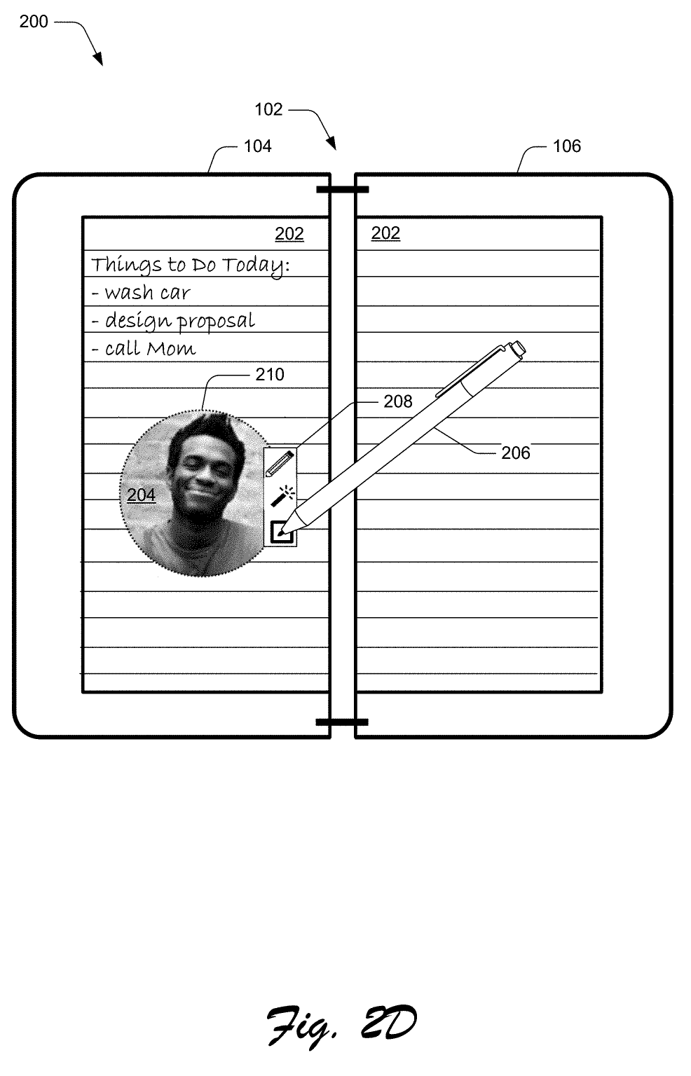

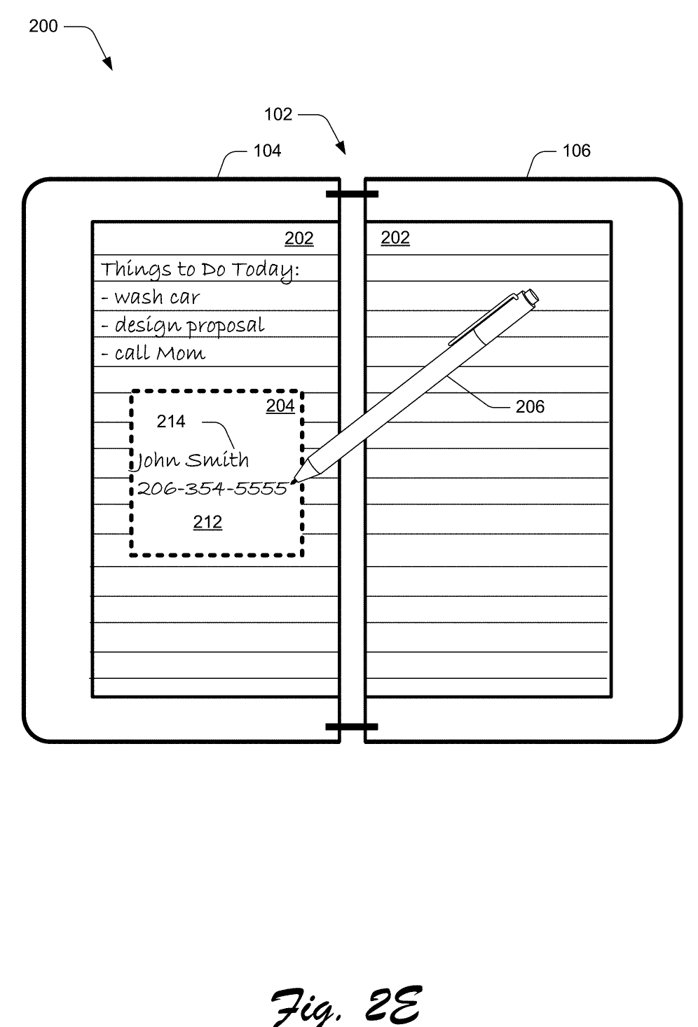

FIGS. 2A-2E illustrate various examples 200 of contextual object manipulation in accordance with one or more implementations.

In FIG. 2A, client device 102 generates digital content as an interactive canvas 202, and displays the interactive canvas 202 on one or more displays. In this example, the interactive canvas 202 is displayed across touch surfaces 110 and 112 of a “dual-display” client device 102, and is associated with a journal application. However, as described throughout, in other cases the interactive canvas 202 may be displayed on a “single-display” device and/or associated with a different type of application. The journal application enables the user to take notes and/or draw on the interactive canvas 202 using an input device, such as a stylus or the user's finger. In this example, the user has written on the upper left corner of the interactive canvas 202 using a stylus 206. As described throughout, however, the user may also provide input to the interactive canvas 202 using the user's finger.

In addition to enabling the user to write or draw on the interactive canvas 202, the interactive canvas 202 also enables the use to insert and manipulate various different types of objects. As described herein, objects may include any type of content, such as images and photos, videos, audio files, text, symbols, drawings, and so forth. One way in which the user can insert an object, is by writing or drawing on the interactive canvas 202 using a stylus or the user's finger. Another way in which the user can insert an object into interactive canvas 202, is by launching an application, such as a web browser, and dragging and dropping various images contained in web pages displayed by the web browser into the interactive canvas 202. In some cases, an object insertion module may enable the user to quickly and efficiently insert an object into the interactive canvas.

In FIG. 2A, client device 102 generates additional digital content as an object 204, and displays the object 204 on the interactive canvas 202. In this example, object 204 corresponds to a picture of a man. The object manipulation module 134 monitors user input to the interactive canvas 202 to determine whether an object is selected or in focus. An object can be selected, or placed in focus, in a variety of different ways, such as using a stylus or a user's finger to touch, tap, double tap, hover, or hold the object. Notably, in FIG. 2A, the stylus 206 is not selecting the object 204.

In response to detecting a selection of an object, the object manipulation module 134 determines a type of the selected object, and causes display of one or more controls that are contextual to the selected object. The one or more controls are contextual to the selected object in that they are associated with functionality that is specific to the type of the selected object. As such, the object manipulation module 134 dynamically provides the one or more controls based on the type of the selected object, such that different controls may be displayed for different types of objects.

For example, if the selected object is a picture, the object manipulation module 134 may display an edit control to enable the user to edit the picture, whereas if the selected object is a video file the one or more controls may include a play button to initiate playback of the video file. In one or more implementations, the one or more controls are displayed in an object manipulation menu that includes at least one global control that is displayed for multiple different types of objects. Global controls that are displayed for all object types may include, for example, copy, delete, resize, and so forth.

In FIG. 2B, the object manipulation module 134 detects a user selection of object 204 when the user controls stylus 206 to hover over object 204. In response to detecting the user selection of object 204, object manipulation module 134 dynamically displays additional digital content as a control 208 that is contextual to the selected object. In this example, because object 204 corresponds to a picture, control 208 corresponds to an image editing control. As described herein, the type of the selected object may correspond to a media type of the selected object, such as picture, video, audio file, text, and so forth. In some cases, the type of the selected object may be more specific, such as profile picture, music file, podcast file, audio recording, telephone number, and so forth.

In one or more implementations, object manipulation module 134 is further configured to alter the additional digital content of the selected object to visually indicate that the object is selected in conjunction with displaying the control, such as by displaying a shadow box or border around the selected object. In FIG. 2B, the object manipulation module 134 display a visual indicator 210 around object 204 to indicate that the object is selected. The visual indicator 210, in this example, corresponds to a dotted border that is displayed around the object 204. Of course, a variety of different visual indicators are contemplated.

In one or more implementations, the object manipulation module 134 displays one or more controls in response to detecting the selection of the object, and then displays additional controls in response to detecting user interaction with the one or more controls indicative of user intent to manipulate the object. For example, if the user controls stylus 206 to hover over control 208, object manipulation module can be implemented to display additional controls.

As an example, consider FIG. 2C in which additional controls 208 are displayed. In this example, the additional controls include a magic wand control and a shape control. In this example, the one or more controls 208 are displayed at a position that overlaps the selected object 204. Alternately, the controls 208 can be displayed proximate the object 204 (without overlapping the object) or at a fixed location of the interactive canvas 202 (e.g., the upper right hand corner of the interactive canvas 202).

By displaying the one or more controls 208 in response to the user selection of the object 204, the user can quickly and easily manipulate the selected object. Thus, in response to a selection of one of the controls 208, the object manipulation module 134 applies the selected control to the selected object 204, such as by resizing, moving, or otherwise editing the selected object 204. For example, in FIG. 2C, the user moves stylus 206 proximate the shape control, and selects the shape control. In response, functionality associated with the shape control is applied to the selected object. For example, in FIG. 2D, in response to selecting the shape control, the shape of the object 204 is changed from a square to a circle. In addition, the controls 208 have changed based on the context of the selected object. For example, the shape control has now changed from a circle to a square because the shape of the object 204 is now circle.

The object manipulation module 134 is configured to remove display of the one or more controls 208 if the controls are not interacted with by the user within a certain period of time (e.g., 2 seconds, 5 seconds, and so forth), or if the selection or focus of the object is changed, such as by moving the stylus 206 off of object 204 or selecting an area of the interactive canvas 202 that does not include the object.

In one or more implementations, the object manipulation module 134 is configured to enable manipulation of an object by enabling the user to add metadata to the object that is then stored as metadata associated with the object, or modify existing metadata associated with the object. To do so, the object manipulation module 134 monitors for user input to add or modify metadata associated with the object, such as when the user taps and holds the object, double taps the object, taps the object while selecting a button on stylus 206, and so forth. In response to detecting the user input to add or modify the metadata associated with the object, the object manipulation module initiates a metadata manipulation mode to enable metadata to be added to the object or existing metadata associated with the object to be modified. In the metadata manipulation mode, the object manipulation module 134 stores writing input received to the object or the interactive canvas as metadata associated with the object.

In one or more implementations, the object manipulation module changes the display of the object to enable the writing input to be received directly on the object. As an example, consider FIG. 2E in which the user has controlled stylus 206 to provide user input to add or manipulate metadata associated with the object, such as by tapping and holding the object 204, double tapping the object 204, tapping the object 204 while selecting a button on stylus 206, and so forth.

In response to the user input, object manipulation module 134 changes the display of the object 204 to enable writing input to be received directly on the object. In this example, the object manipulation module 134 has changed the display of the object 204 by displaying the object 204 with a blank surface 212 configured to receive writing input. The object manipulation module 134 receives writing input 214 to the blank surface 212 of the object 204 when the user writes the name of the man in the picture of object 204 (“John Smith) as well as a phone number of the man (“206-354-5555”) on the blank surface 212 of the object 204.

In response to receiving the writing input 214, the object manipulation module stores the writing input 214 as metadata associated with the object 204. In some cases, if the object 204 includes existing metadata, then this metadata may be displayed on the blank surface 212 of the object 204, such that the user can also modify or edit the existing metadata.

In one or more implementations, the object manipulation module 134 provides a visual effect to display the blank surface of object 204, such as by causing the object 204 to flip over to reveal a backside of the object corresponding to the blank surface.

Having described some example implementation scenarios, consider now some example procedures for contextual object manipulation in accordance with one or more implementations.

The following discussion describes example procedures for contextual object manipulation in accordance with one or more embodiments. The example procedures may be employed in the environment 100 of FIG. 1, the system 500 of FIG. 5, and/or any other suitable environment. The procedures, for instance, represent procedures for implementing the example implementation scenarios discussed above.

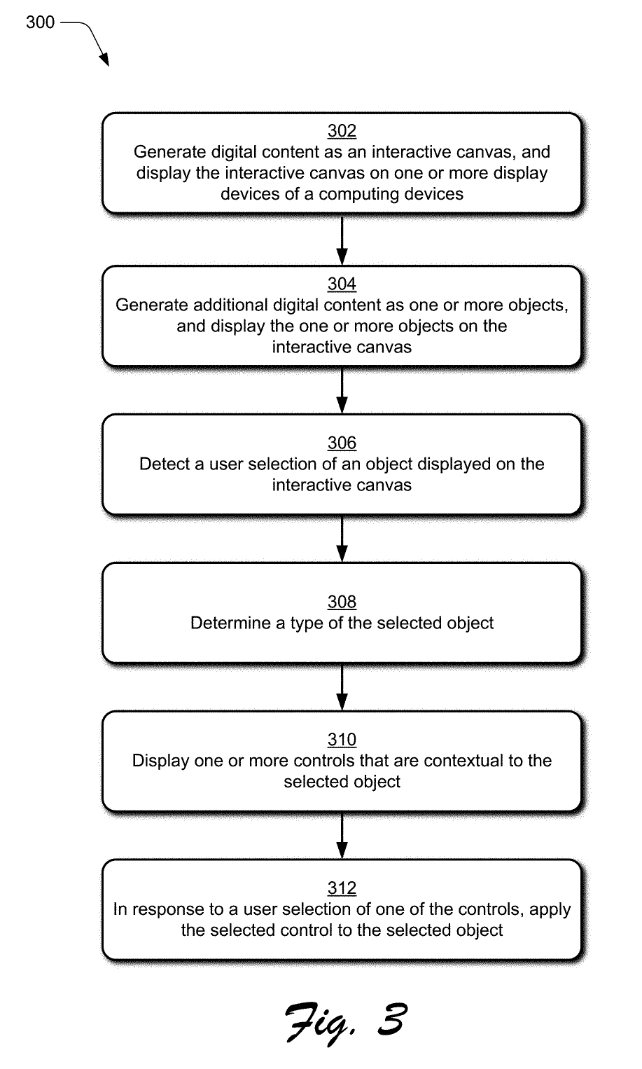

FIG. 3 is a flow diagram that describes steps in a method for contextual object manipulation in accordance with one or more implementations.

At 302, digital content is generated as an interactive canvas, and the interactive canvas is displayed on one or more display devices of a computing device. For example, client device 102 generates digital content as interactive canvas 202, and displays the interactive canvas 202 on display devices 104 or 106.

At 304, additional digital content is generated as one or more objects, and the one or more objects are displayed on the interactive canvas. For example, additional digital content as an object 204 is generated and displayed in an interactive canvas 202.

At 306, a user selection of an object displayed on the interactive canvas is detected. For example, object manipulation module 134 detects a user selection of object 204 when a stylus 206 is controlled to hover over object 204.

At 308, a type of the selected object is determined. For example, object manipulation module 134 determines a type of the selected object 204. The determined type of an object may include, by way of example and not limitation, a picture, a video, an audio file, or text.

At 310, one or more controls that are contextual to the selected object are displayed. For example, object manipulation module 134 displays one or more controls 208 that are contextual to the selected object 204 on the interactive canvas 202.

At 312, in response to a user selection of one of the controls, the selected control is applied to the selected object. For example, object manipulation module 134 applies functionality associated with a selected control 208 to the selected object 204.

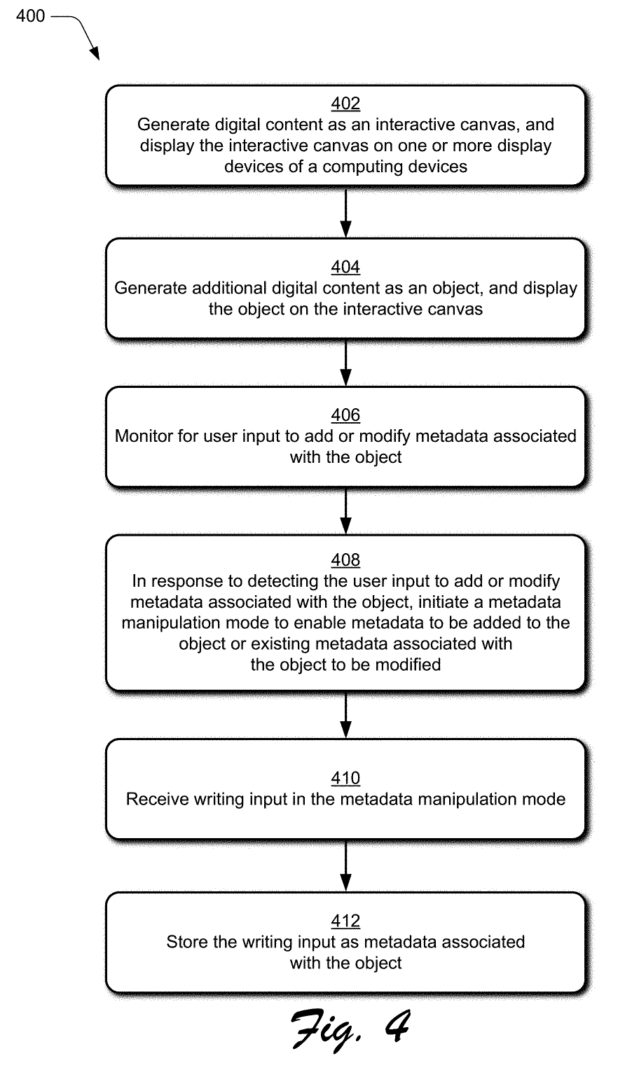

FIG. 4 is a flow diagram that describes steps in an additional method for contextual object manipulation in accordance with one or more implementations.

At 402, digital content is generated as an interactive canvas, and the interactive canvas is displayed on one or more display devices of a computing device. For example, client device 102 generates digital content as interactive canvas 202, and displays the interactive canvas 202 on display devices 104 or 106.

At 404, additional digital content is generated as an object, and the object is displayed on the interactive canvas. For example, additional digital content as an object 204 is generated and displayed in an interactive canvas 202.

At 406, user input to add or modify metadata associated with the object is monitored, and at 408 in response to detecting the user input to add or modify metadata associated with the object, a metadata manipulation mode is initiated to enable metadata to be added to the object or existing metadata associated with the object to be modified. For example, in response to the user input, object manipulation module 134 changes the display of the object 204 to enable writing input to be received directly on the object. In some cases, the object manipulation module 134 changes the display of the object 204 by displaying the object 204 with a blank surface 212 configured to receive writing input.

At 410, in the metadata manipulation mode, writing input is received, and at 412 the writing input is stored as metadata associated with object. For example, the object manipulation module 134 receives writing input 214 to the blank surface 212 of the object 204 when the user writes the name of the man in the picture of object 204 (“John Smith) as well as a phone number of the man (“206-354-5555”) on the blank surface 212 of the object 204. In response to receiving the writing input 214, the object manipulation module stores the writing input 214 as metadata associated with the object 204. In some cases, if the object 204 includes existing metadata, then this metadata may be displayed on the blank surface 212 of the object 204, such that the user can also modify or edit the existing metadata.

FIG. 5 illustrates an example system generally at 500 that includes an example computing device 502 that is representative of one or more computing systems and/or devices that may implement the various techniques described herein. In at least some implementations, the computing device 502 represents an implementation of the client device 102 discussed above. The computing device 502 may, for example, be configured to assume a mobile configuration through use of a housing formed and sized to be grasped and carried by one or more hands of a user, illustrated examples of which include a mobile phone, mobile game and music device, and tablet computer although other examples are also contemplated. In at least some implementations, the client device 102 may be implemented as a wearable device, such as a smart watch, smart glasses, a dual-surface gesture-input peripheral for a computing device, and so forth.

The example computing device 502 as illustrated includes a processing system 504, one or more computer-readable media 506, and one or more I/O interface 508 that are communicatively coupled, one to another. Although not shown, the computing device 502 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 504 is representative of functionality to perform one or more operations using hardware. Accordingly, the processing system 504 is illustrated as including hardware element 510 that may be configured as processors, functional blocks, and so forth. This may include implementation in hardware as an application specific integrated circuit or other logic device formed using one or more semiconductors. The hardware elements 510 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 506 is illustrated as including memory/storage 512. The memory/storage 512 represents memory/storage capacity associated with one or more computer-readable media. The memory/storage component 512 may include volatile media (such as random access memory (RAM)) and/or nonvolatile media (such as read only memory (ROM), Flash memory, optical disks, magnetic disks, and so forth). The memory/storage component 512 may include fixed media (e.g., RAM, ROM, a fixed hard drive, and so on) as well as removable media (e.g., Flash memory, a removable hard drive, an optical disc, and so forth). The computer-readable media 506 may be configured in a variety of other ways as further described below.

Input/output interface(s) 508 are representative of functionality to allow a user to enter commands and information to computing device 502, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 502 may be configured in a variety of ways to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 502. By way of example, and not limitation, computer-readable media may include “computer-readable storage media” and “computer-readable signal media.”

“Computer-readable storage media” may refer to media and/or devices that enable persistent storage of information in contrast to mere signal transmission, carrier waves, or signals per se. Thus, computer-readable storage media refers to non-signal bearing media and does not include signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 502, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 510 and computer-readable media 506 are representative of modules, programmable device logic and/or fixed device logic implemented in a hardware form that may be employed in some implementations to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 510. The computing device 502 may be configured to implement particular instructions and/or functions corresponding to the software and/or hardware modules. Accordingly, implementation of a module that is executable by the computing device 502 as software may be achieved at least partially in hardware, e.g., through use of computer-readable storage media and/or hardware elements 510 of the processing system 504. The instructions and/or functions may be executable/operable by one or more articles of manufacture (for example, one or more computing devices 502 and/or processing systems 504) to implement techniques, modules, and examples described herein.

Example implementations described herein include, but are not limited to, one or any combinations of one or more of the following examples:

In one or more examples, a computing device comprises: at least one processor; and at least one computer-readable storage media storing instructions that are executable by the at least one processor to perform operations comprising: generating digital content as an interactive canvas; displaying the interactive canvas on the one or more display devices of the computing device; generating additional digital content as one or more objects, and display the one or more objects on the interactive canvas; detecting a user selection of an object displayed on the interactive canvas; determining a type of the selected object; displaying one or more controls that are contextual to the selected object; and in response to a user selection of one of the controls, apply the selected control to the selected object.

An example as described alone or in combination with any of the other examples described above or below, wherein the operations further comprise visually indicating that the object is selected in response to detecting the user selection of the object.

An example as described alone or in combination with any of the other examples described above or below, wherein the operations further comprise removing display of the one or more controls if the one or more controls are not interacted with by the user within certain period of time or in response selection of an area of the interactive canvas which does not include the object.

An example as described alone or in combination with any of the other examples described above or below, wherein the operations further comprise, in response to detecting user input to add or modify metadata associated with the object, initiating a metadata manipulation mode to enable metadata to be added to the object or existing metadata associated with the object to be modified.

An example as described alone or in combination with any of the other examples described above or below, wherein the operations further comprise: in the metadata manipulation mode, receiving writing input; and storing the writing input as metadata associated with object.

An example as described alone or in combination with any of the other examples described above or below, wherein the one or more controls are displayed based on the type of the selected object.

An example as described alone or in combination with any of the other examples described above or below, wherein at least one different control is displayed for a different type of selected object.

An example as described alone or in combination with any of the other examples described above or below, wherein the one or more controls are displayed in an object manipulation menu that includes at least one global control that is displayed for multiple different types of objects.

An example as described alone or in combination with any of the other examples described above or below, wherein the one or more controls are displayed proximate the selected object.

An example as described alone or in combination with any of the other examples described above or below, the one or more controls are displayed at a fixed location of the interactive canvas.

An example as described alone or in combination with any of the other examples described above or below, wherein the selected object comprises an image, a video, an audio file, or text.

An example as described alone or in combination with any of the other examples described above or below, wherein the computing device comprises a dual-display device comprising a first display device and a second display device, and wherein the interactive canvas is displayed on both the first and second display devices of the dual-display device as pages of a journal application.

In one or more examples, a method implemented by a computing device comprises: generating digital content as an interactive canvas; displaying the interactive canvas on the one or more display devices of the computing device; generating additional digital content as an object, and displaying the object on the interactive canvas; monitoring for user input to add or modify metadata associated with the object; in response to detecting the user input to add or modify metadata associated with the object, initiating a metadata manipulation mode to enable metadata to be added to the object or existing metadata associated with the object to be modified; in the metadata manipulation mode, receiving writing input; and storing the writing input as metadata associated with object.

An example as described alone or in combination with any of the other examples described above or below, further comprising, in the metadata manipulation mode, changing the display of the object to enable the writing input to be received directly on the object.

An example as described alone or in combination with any of the other examples described above or below, wherein the changing the display of the object comprises displaying the object with a blank surface in the metadata manipulation mode, and wherein the writing input is received to the blank surface of the object.

An example as described alone or in combination with any of the other examples described above or below, further comprising, in the metadata manipulation mode, causing display of the existing metadata associated with the object to enable modification of the existing metadata.

In one or more examples, a method implemented by a computing device comprises: generating digital content as an interactive canvas; displaying the interactive canvas on the or more display devices of the computing device; generating additional digital content as one or more objects, and display the one or more objects on the interactive canvas; detecting a user selection of an object displayed on the interactive canvas; determining a type of the selected object; displaying one or more controls that are contextual to the selected object; and in response to a user selection of one of the controls, applying the selected control to the selected object.

An example as described alone or in combination with any of the other examples described above or below, further comprising removing display of the one or more controls if the one or more controls are not interacted with by the user within certain period of time or in response selection of an area of the interactive canvas which does not include the object.

An example as described alone or in combination with any of the other examples described above or below, further comprising in response to detecting user input to add or modify metadata associated with the object, initiating a metadata manipulation mode to enable metadata to be added to the object or existing metadata associated with the object to be modified.

An example as described alone or in combination with any of the other examples described above or below, further comprising in the metadata manipulation mode, receiving writing input, and storing the writing input as metadata associated with object.

Although the example implementations have been described in language specific to structural features and/or methodological acts, it is to be understood that the implementations defined in the appended claims is not necessarily limited to the specific features or acts described. Rather, the specific features and acts are disclosed as example forms of implementing the claimed features.

What is claimed is:

1. A computing device comprising:
at least one processor; and
at least one computer-readable storage media storing instructions that are executable by the at least one processor to perform operations comprising:
generating digital content as an interactive canvas;
displaying the interactive canvas on the one or more display devices of the computing device;
generating additional digital content as one or more objects, and displaying the one or more objects on the interactive canvas;
detecting a user selection of an object displayed on the interactive canvas;
determining a type of the selected object;
displaying one or more controls that are contextual to the selected object; and
in response to a user selection of one of the controls, apply the selected control to the selected object.

2. The computing device of claim 1, wherein the operations further comprise visually indicating that the object is selected in response to detecting the user selection of the object.

3. The computing device of claim 1, wherein the operations further comprise removing display of the one or more controls if user interaction to the one or more controls is not received within certain period of time or in response selection of an area of the interactive canvas which does not include the object.

4. The computing device of claim 1, wherein the operations further comprise, in response to detecting user input to add or modify metadata associated with the object, initiating a metadata manipulation mode to enable metadata to be added to the object or existing metadata associated with the object to be modified.

5. The computing device of claim 4, wherein the operations further comprise:
in the metadata manipulation mode, receiving writing input; and
storing the writing input as metadata associated with object.

6. The computing device of claim 1, wherein the one or more controls are displayed based on the type of the selected object.

7. The computing device of claim 1, wherein at least one different control is displayed for a different type of selected object.

8. The computing device of claim 1, wherein the one or more controls are displayed in an object manipulation menu that includes at least one global control that is displayed for multiple different types of objects.

9. The computing device of claim 1, wherein the one or more controls are displayed proximate the selected object.

10. The computing device of claim 1, wherein the one or more controls are displayed at a fixed location of the interactive canvas.

11. The computing device of claim 1, wherein the selected object comprises an image, a video, an audio file, or text.

12. The computing device of claim 1, wherein the computing device comprises a dual-display device comprising a first display device and a second display device, and wherein the interactive canvas is displayed on both the first and second display devices of the dual-display device as pages of a journal application.

13. A method implemented by a computing device, the method comprising:
generating digital content as an interactive canvas;
displaying the interactive canvas on the one or more display devices of the computing device;
generating additional digital content as an object, and displaying the object on the interactive canvas;
monitoring for user input to add or modify metadata associated with the object;
in response to detecting the user input to add or modify metadata associated with the object, initiating a metadata manipulation mode to enable metadata to be added to the object or existing metadata associated with the object to be modified;
in the metadata manipulation mode, receiving writing input; and
storing the writing input as metadata associated with object.

14. The method of claim 13, further comprising, in the metadata manipulation mode, changing the display of the object to enable the writing input to be received directly on the object.

15. The method of claim 14, wherein the changing the display of the object comprises displaying the object with a blank surface in the metadata manipulation mode, and wherein the writing input is received to the blank surface of the object.

16. The method of claim 13, further comprising, in the metadata manipulation mode, causing display of the existing metadata associated with the object to enable modification of the existing metadata.

17. A method implemented by a computing device, the method comprising:
generating digital content as an interactive canvas;
displaying the interactive canvas on the or more display devices of the computing device;
generating additional digital content as one or more objects, and display the one or more objects on the interactive canvas;
detecting a user selection of an object displayed on the interactive canvas;
determining a type of the selected object;
displaying one or more controls that are contextual to the selected object; and
in response to a user selection of one of the controls, applying the selected control to the selected object.

18. The method of claim 17, further comprising removing display of the one or more controls if the one or more controls are not interacted with by the user within certain period of time or in response selection of an area of the interactive canvas which does not include the object.

19. The method of claim 17, further comprising in response to detecting user input to add or modify metadata associated with the object, initiating a metadata manipulation mode to enable metadata to be added to the object or existing metadata associated with the object to be modified.

20. The method of claim 19, further comprising in the metadata manipulation mode, receiving writing input, and storing the writing input as metadata associated with object.
